(19) United States
(12) Patent Application Publication
(10) Pub. No.: US 2008/0104418 A1
(43) Pub. Date: May 1, 2008

(54) APPARATUS, AND ASSOCIATED METHOD, FOR PROVIDING AN ELECTRONIC STORAGE BOX FOR SECURELY STORING DATA IN ELECTRONIC FORM

(75) Inventor: David R. Parnell, Castle Hill (AU)

Correspondence Address: DOCKET CLERK, P.O. BOX 12608, DALLAS, TX, 75225, US

(73) Assignee: ELECTONIC DATA SYSTEMS CORPORATION, Plano, TX (US)

(21) Appl. No.: 11/552,679

(22) Filed: Oct. 25, 2006

(51) Int. Cl. G06F 12/14; H04L 9/32; G06F 11/30

(52) U.S. Cl. 713/193

(57) ABSTRACT

Apparatus, and an associated methodology, for archiving electronic data at an electronic security box. A front-end user makes arrangements with a trusted data manager, such as a banking entity, for the creation of an electronic security box. The trusted data manager arranges with a back-end facility operator for the formation of the electronic security box. Once created, the front-end user is provided with selectable access to the electronic security box, both to store data in electronic form thereat and to retrieve the contents, once stored.

The present invention relates generally to the secure storage of data in electronic form. More particularly, the present invention relates to apparatus, and an associated method, that provides electronic storage boxes for storing electronic data of consumers, or other front-end users, at a secure, back-end facility and for permitting selected access by the front-end users to the electronic security boxes.

The secure, back-end facility at which the electronic security boxes are provided is operated by a facility operator, and the front-end user purchases access to an electronic security box by way of a trusted data manager.

### BACKGROUND OF THE INVENTION

Data record storage and maintenance has long been a necessary aspect of society. Data records are required to be created and maintained in manners to permit their subsequent retrieval and review. Data records, of course, have been created and maintained in paper form dating back into antiquity. While storage of data records in paper form is adequate for long-term storage of the data records, the longevity of such paper data records is, of course, dependent upon the longevity of the paper upon which the data records are recorded. The paper upon which the data records are recorded is susceptible to degradation such as that caused by environmental conditions. Moisture, heat, and other ambient parameters affect the longevity of the paper and if the ambient parameters are severe, the paper upon which the data records is recorded might be destroyed or be degraded to an extent that prevents the subsequent review and use of the data records. Paper records also are relatively bulky and, when large numbers of paper-recorded records need to be stored, a data depository, such as a storage warehouse, is required to be available.

Advancements in technology have progressively provided additional options by way of which to store data records. Microfilm storage of the data records, for instance, provides a manner by which to store the data records on a long-term basis in much-miniaturized form relative to storage of the data records in paper form. Advancements in digital data processing, manipulation, and communication techniques, however, have permitted the development and use of data storage devices that provide for the long-term storage of very large amounts of data records, in some implementations, essentially indefinitely while still providing for their speedy retrieval, when needed.

Computer servers, and their associated large-scale elements, for instance, provide for the storage and subsequent retrieval of very large amounts of data or numbers of data records. A relatively high level of technical sophistication is required to maintain a computer server, and its associated storage elements, in operation. And, such devices are relatively costly. While there is a present need for many to be able to create and store data records in a manner permitting their subsequent retrieval and use, the costs and expertise required to store such data at a computer server is sometimes prohibitive. Additionally, the data records are sometimes of a confidential nature. And, the data records must be stored in a manner that prohibits all but those who are authorized to access the stored records.

When stored in paper form, data records that must be stored with a high level of security can be stored in safe deposit boxes, such as those provided by conventional banking facilities. Conventionally, a safe deposit box is provided to a banking customer, available to the customer to store the paper documents of the data records, literally under lock and key. And, the safe deposit box is positioned within a vault to which access is limited. A banking facility typically maintains a limited number of safe deposit boxes in which even the largest of such safe deposit boxes are of limited volumetric dimensions. That is to say, even the largest of available safe deposit boxes are permitting of storage of only limited amounts of materials or documents.

With the seeming need to store securely ever-increasing amounts and types of sensitive and confidential data records, their storage in paper form, such as at a safe deposit box, is increasingly difficult. And, for many, maintenance of a secure computer server and associated data storage medium at which to store the data records in electronic form is impractical.

What is needed, therefore, is an improved manner by which to store data records, in electronic form, in a secure manner that permits only authorized access to the data records.

It is in light of this background information related to data storage that the significant improvements of the present invention have evolved.

### SUMMARY OF THE INVENTION

The present invention, accordingly, advantageously provides apparatus, and an associated method, for securely storing data in electronic form.

Through operation of an embodiment of the present invention, a manner is provided by which to provide electronic storage boxes for storing electronic data of consumers, or other front-end users. The electronic storage boxes are formed and maintained at a secure, back-end facility. And, selected access to the electronic storage boxes, and the electronic data stored therein, is permitted.

In one aspect of the present invention, the back-end facility at which the electronic security boxes are formed and maintained is operated by a facility operator. A front-end user purchases access to an electronic security box of a selected storage capacity and is permitted thereafter to store data in electronic form thereat and to the stored contents and to remove and to replace the stored contents as well as subsequently to store additional electronic data thereat. The front-end user purchases the access to the electronic security box by a trusted data manager, an entity, e.g., different than the entity forming the operator of the back-end facility.

The front-end user interacts, e.g., with a trusted data provider regarding the storage of data at the electronic security box. And, the electronic security box is provided by way of interaction between the front-end user and the trusted data manager and, in turn, between the trusted data manager and the operator of the back-end facility. A storage agreement provides also, or alternately, for the trusted data provider to store data at the electronic security box data stored for the benefit of, or otherwise associated with, the front-end user. The trusted data provider comprises, for instance, a taxing body or entity, a governmental social security entity, a governmental property recorder, a banking or financial entity, or any other entity that prepares or provides data associated with the front-end user.

In another aspect of the present invention, the back-end facility is provided at a secure location at which physical and electronic access is limited. The back-end facility includes a storage device, such as one or more computer servers and associated data storage medium permitting of formation of electronic storage boxes thereat. The electronic storage boxes are of selected storage capacities and, e.g., are of configurable storage capacities. That is to say, the electronic security box is configurable to be of any of various storage capacities. A front-end user is thereby able to purchase, or subscribe to, an electronic storage box of a storage capacity best fitting the needs of the front-end user.

The back-end facility operator maintains the electronic security boxes at which the front-end user stores the electronic data. By providing for a trusted data manager, the facility operator need not be in privity with, or even known to, the front-end user. Rather, arrangements for provision of the electronic security box to a front-end user are made between the front-end user and the trusted data manager. And, in turn, the trusted data manager arranges with the back-end facility operator for the providing of the electronic security box to the front-end user. The expertise of the back-end facility operator relating to the mechanics of the secure electronic storage of the data is provided for the benefit of the front-end user. And, the expertise of the trusted data manager, such as, e.g., various business support activities with respect to the front-end user also is provided to the front-end user.

In another aspect of the present invention, the trusted data manager provides the access parameters that are required to be submitted for the front-end user to obtain access to the electronic security box purchased by the front-end user. The parameters are, for instance, obtained by the trusted manager from the front-end user. For instance, the access parameters comprise passwords, authentication information, or other like parameters, requested of the front-end user by the trusted data manager and thereafter provided to a trusted data manager controller that controls the access to the storage element at which the electronic security box is maintained. Again, as the trusted data manager interacts with the front-end user, the parameters are obtained or created without need for direct privity between the back-end facility operator and the front-end user.

The access parameters, provided to the controller by the trusted data manager are subsequently used thereat to authenticate, or otherwise identify, the front-end user prior to permitting subsequent access to the electronic security box.

The controller is connected to a communication medium such as the Internet to which the front-end user is also connectable. The user, when desiring access to the electronic security box, communicates, by way of the Internet or other communication medium, with the controller that operates to control access to the electronic security box. If the user is required to be authenticated, such as through submission of the access parameters that correspond with the access parameters previously provided to the controller by the trusted data manager, prior to permission by the controller granted to the front-end user to access the associated electronic security box. Authentication techniques, such as exchange of security keys, are, for instance, required prior to grant of access to the front-end user of the user's electronic security box.

Any data amenable for storage in electronic form is storable at the electronics security box. For instance, statements, property deeds, tax returns, and personal data of the front-end user is all storable at the electronic security box. The expertise of the back-end facility operator in terms of the secure storage of electronic data is provided to the front-end user. And, the trusted data manager is provided with an additional service available to the front-end user.

The trusted data manager comprises, for instance, a banking, or similar, institution. Customers of the banking institution are thereby provided with an additional storage mechanism dedicated to storage of data in electronic form, in addition to conventional safe deposit boxes typically provided by a banking institution.

In these and other aspects, therefore, apparatus, and an associated method, is provided for archiving front-end user data of a front-end user in electronic form. The user data is stored at a back-end facility maintained by a facility operator. A storage device is positioned at the back-end facility. The storage device is configured selectably to store the front-end user data at an electronic security box, formed selectably at the storage device. And, the storage device is configured selectably to permit access to the electronic security box. A trusted data manager controller is positionable in communication connectivity with the storage device. The trusted data manager controller is configured to cause creation of the electronic security box formed at the storage device and to cause selection of access parameters that define access criteria provided for access to the data stored thereat.

### BRIEF DESCRIPTION OF THE DRAWINGS

FIG. 1 illustrates a functional block diagram of an assembly of an embodiment of the present invention by which to provide a front-end user with an electronic storage box.

FIG. 2 illustrates a process diagram representative of the process of an embodiment of the present invention.

FIG. 3 illustrates a functional block diagram of the assembly shown in FIG. 1, here showing signaling generated during exemplary operation of an embodiment of the present invention.

FIG. 4 illustrates a functional block diagram, similar to that shown in FIG. 3, but here showing signaling generated during other exemplary operation of an embodiment of the present invention.

FIG. 5 illustrates a method flow diagram showing the method of operation of an embodiment of the present invention.

### DETAILED DESCRIPTION

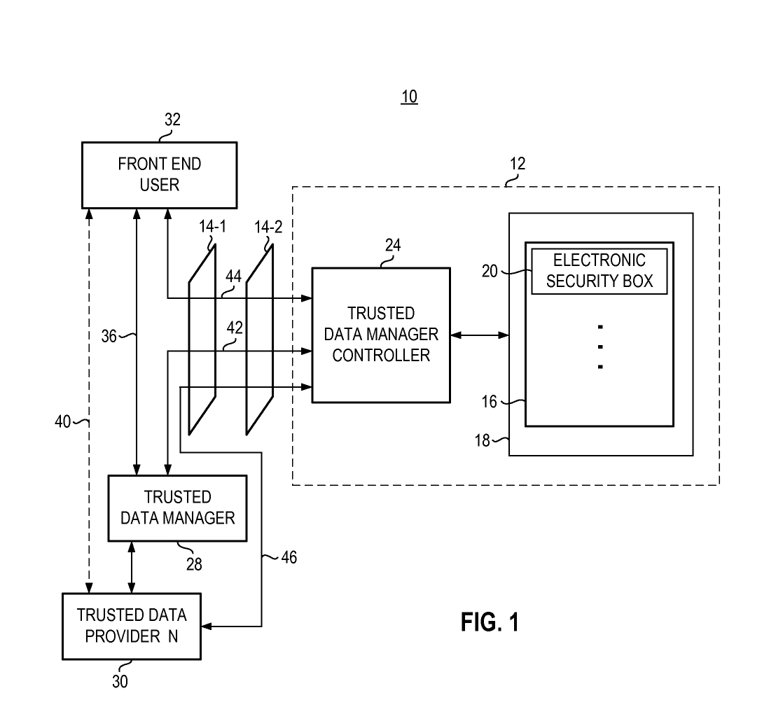

Turning first to FIG. 1, an arrangement, shown generally at 10, includes an assembly 12 of an embodiment of the present invention. The assembly is constructive, e.g., behind one or more firewalls or other security protection 14, and the assembly includes a storage element 16 positioned at a physically isolated area defined at, or formed of, a back-end facility.

In the exemplary implementation, the storage element 16 comprises a computer server and its associated data storage medium of a desired capacity. The back-end facility and the physically isolated area thereof is of dimensions and of ambient conditions that are permitting of operation and maintenance of one or more computer servers and associated data storage medium. The back-end facility is preferably of dimension in construction to permit scalability of the storage element 16, that is to say, is permitting of increase in the storage capacity of the storage element, such as by increasing the number of computer servers or data storage medium maintained at the back-end facility.

The storage element is configurable into storage locations of selected storage capacities. The storage locations define electronic storage boxes 20 and the associated storage capacities are determinative of the amount of data storable therein. In one implementation, the storage capacity of any particular electronic storage box is reconfigurable, to be increased in storage capacity or to be of reduced storage capacity, to match the storage capacity of the electronic storage box with the data that is to be stored therein. Subsequent to initial sizing of an electronic storage box, if the storage needs change, the storage capacity of the electronic storage box is resized, as needed. Repeated resizings of the storage capacity is possible, each time in which there is a change in data storage needs of data to be stored at the electronic storage box. And, when scalability is available at the back-end facility, the storage capacities of the electronic storage boxes is readily as large as any practical need.

A trusted data manager controller 24 controls access to the storage element and the electronic storage boxes formed thereat. The controller 24 is here shown to be positioned outside of the back-end facility and the physically isolated area at which the storage element 16 is positioned. In other implementations, the controller is, instead, positioned within the back-end facility and, in one implementation, is embodied, in part, or in its entirety, at a computer server at which the storage element 16 is also embodied or forms a portion. The controller, in the exemplary implementation, not only controls access to the storage element, but also is used in the configuration, and, if needed, reconfiguration, of the electronic storage boxes defined at the storage element. An external access request that requests access to an electronic storage box is acted upon by the controller, either to provide for the requested access or to deny the requested access. Access is permitted, pursuant to successful completion of an authentication procedure of the requester that submits the request for access to the electronic storage box. Key-exchange procedures, or the like, and password requirements are performed with, or satisfied by, the controller prior to permitting grant of access to an electronic storage box. When, as illustrated, the controller is positioned behind the firewalls or other security protection 14, additional, conventional security mechanisms associated with the firewall or other security protection provide further limitations on access to the controller and, in turn, the storage element 16.

The arrangement further illustrates a trusted data manager 28, a trusted data provider N 30, and a front-end user 32. The designation “N” of the trusted data provider represents an implementation including a plurality of N trusted data providers (TDPs), each providing data associated with the front end user. The front-end user and the trusted data manager are at least selectably in communication connectivity, here represented by way of the line 36. The front-end user is, for instance, a retail customer of a business entity of which the trusted data manager is associated. The communication connectivity represented by the line 36 is of any type. For instance, the communication connectivity comprises person-to-person interaction, such as visitation by the retail consumer forming the front-end user visiting the business establishment of the business entity of which the trusted data manager is associated. Or, the communication connectivity is representative of remote communications, such as that effectuated by way of phone or other communication medium. Such a communication medium is of any appropriate type, electrical, electromagnetic, written, or other communication medium permitting of conveying information between the front-end user and the trusted data manager.

The front-end user and the trusted data provider are also selectably in communication connectivity with one another, here indicated by the line 40.

In the exemplary implementation, both the front-end user and the trusted data manager are positionable in communication connectivity with the trusted data manager controller 24. The communication connectivity between the trusted data manager and the trusted data manager controller is represented by the line 42, and the communication connectivity between the front-end user and the trusted data manager controller is represented by the line 44. In one implementation, the controller 24 is controlled by the same entity with which the trusted data manager is associated. Communication paths formable between the trusted data manager and the controller and between the front-end user and the controller are effectuated, in the exemplary implementation, by way of Internet connections by way of the firewalls or other security protection 14. And, as indicated by the line 46, a communication path is formable between the trusted data provider and the trusted data manager controller.

In exemplary operation, an arrangement is made between the front-end user and the trusted data manager for provision to the front-end user of an electronic storage box at the storage element of the back-end facility for the front-end user's use. And, upon making of such arrangements, the trusted data manager informs an operator of the back-end facility of the arrangement. The trusted data manager here, instructs the controller to cause the creation of the electronic storage box of a desired configuration, i.e., memory capacity, and to provide parameters to permit the front-end user subsequently to access the electronic security box. Once the electronic security box is configured and the access parameters are set, the front-end user is thereafter able to access the electronic security box by complying with the set access parameters. By providing the access parameters, or completing procedures associated therewith, the front-end user is able both to store data at the electronic security box and also to retrieve data previously stored thereat. Changes to retrieved documents can be made by the front-end user and then stored again at the electronic security box. The front-end user is able to access the contents of the electronic security box without further direct interaction with the trusted data manager by way of the communication connectivity represented by the line 44. If, subsequently, reconfiguration of the size of the electronic security box is required, the front-end user again contacts the trusted data manager, and the trusted data manager causes the reconfiguration to be carried out.

In the exemplary implementation, the trusted data manager and the operator of the back-end facility are separate entities. And, the front-end user need not know of the back-end facility operator, but rather makes arrangements for the creation, and use, of the electronic security box by way of the trusted data manager. The product, and service, associated with the electronic security box, if desired, is branded by the business entity with which the trusted data manager is associated. For instance, if the business entity is a banking establishment, the electronic security box is branded with the trade name or logo of the banking establishment. From the perspective of the front-end user, the electronic security box is part of the banking establishment with which the front-end user makes the arrangements for its creation. And, as the electronic security box is formed at, and maintained by, the operator of the back-end facility, expertise associated with data storage, and security associated with the storage of data, is made available to the front-end user.

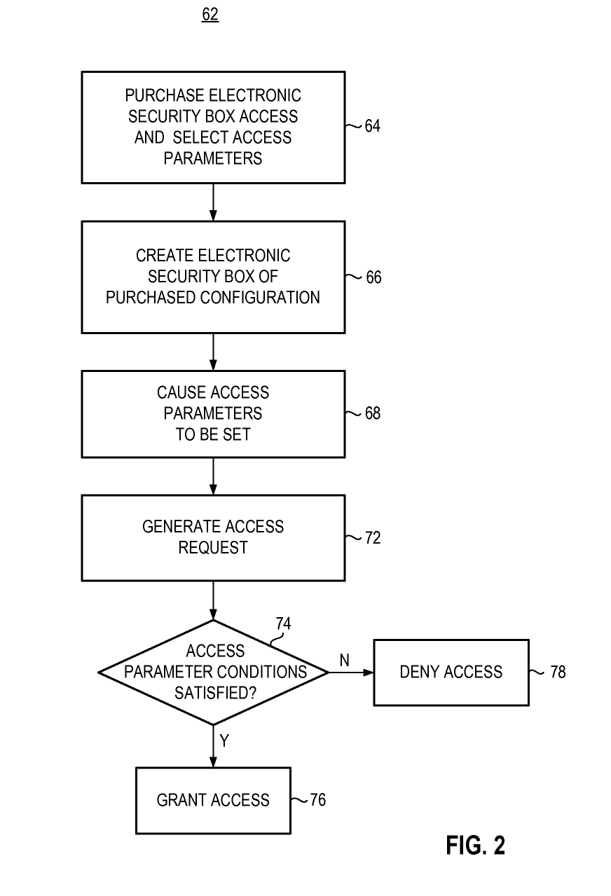

FIG. 2 illustrates a process, shown generally at 62, representative of operation of an embodiment of the present invention, implemented, e.g., by way of the arrangement 10 shown in FIG. 1. The process provides for the creation of an electronic security box that is accessible, subsequent to its creation by an owner of the security box, that is to say, a person or entity that purchases access, for at least a selected time period, to the electronic security box. The electronic security box provides for the secure storage of electronic data, such as documents in electronic form. Tax records, billing information, business records, and any other data amenable for storage in electronic form are storable at the electronic security box.

First, and as indicated by the block 64, a front-end user purchases access to an electronic security box. The purchase criteria include the storage capacity of the electronic security box and the duration of the access. The access is, for instance, by way of a subscription that is renewed at selected renewal intervals. The purchase is made through contract with a trusted data manager. In an exemplary application, the trusted data manager is a banking entity or a representative of the banking entity, and the front-end user is a customer of the banking entity. At the time of purchase, various details associated with the electronic security box purchase are additionally arranged, such as selection of access parameters that control access by the front-end user to the electronic security box.

Subsequently, the trusted data manager causes creation, indicated by the box 66, of the electronic security box. The creation is carried out by instructing a back-end facility operator, or equipment of the back-end facility operator, to create the electronic security box. And, in response to the instructions for its creation, the electronic security box of the desired configuration is created. And, the trusted data manager also causes, as indicated by the block 68, the setting of the access parameters.

Upon creation of the electronic security box and setting of the access parameters, the electronic security box is ready for use by the front-end user. When the front-end user desires access to the electronic security box, the user generates an access request, indicated by the block 72, to request access to the electronic security box. The access request includes, or is part of a procedure, that identifies the access parameters needed to be presented by the user so that access responsive to the request can be granted.

Then, and as indicated by the decision block 72, a determination is made as to whether the access parameters have been satisfied. If so, the yes branch is taken, and access is granted, indicated by the block 76. If the access parameters have not been satisfied, the no branch is taken, and access is denied, indicated by the block 78.

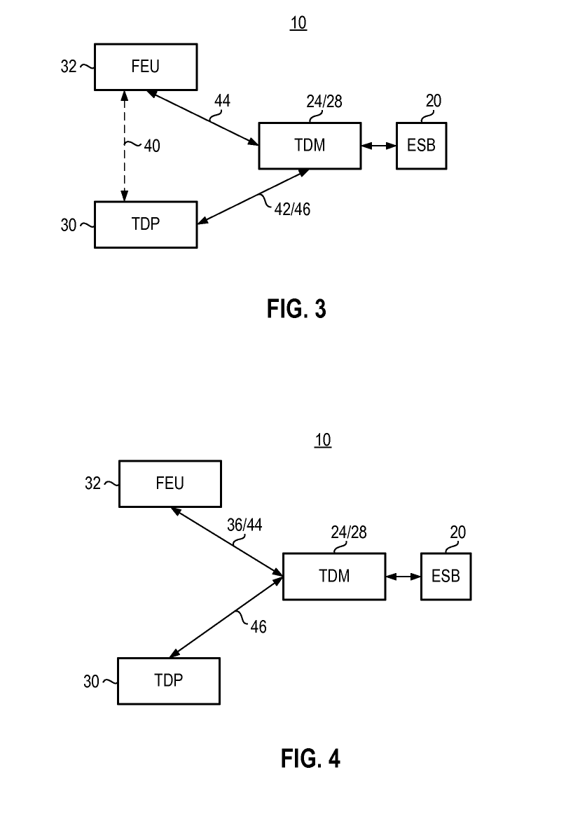

FIG. 3 again illustrates portions of the arrangement 10 shown in FIG. 1. Here, the front-end electronic security box (ESB) 20, the trusted data manager and the controller 28/24, the trusted data provider 30, and the front-end user 32 are shown. The lines 40, 36/44, 44, and 42/46 are again shown, representative of the communication connectivity between the illustrated elements.

Here, the trusted data provider 30 interacts with the front-end user 32 by way of the communication path 40 to request and/or receive approval for electronic lodgment of electronic data at the electronic security box created for the benefit of the front-end user. The trusted data provider also interacts with the trusted data manager and controller 28/24. The trusted data provider is representative of, e.g., a taxing revenue agency, a social security agency, a land or property deed agency, or a banking or finance institution. In one implementation, the trusted data provider pays fees to the trusted data manager for the capability to lodge electronic data at an electronic security box.

During exemplary operation, the front-end user and the trusted data provider agree upon details by way of the communication path 40 for the lodgment of secure electronic data at the electronic security box. Upon such agreement, the front-end unit lodges approval, here by way of the line 44, for new electronic data from the approved trusted data provider. And, the trusted data manager approves, also by way of the line 44, the new lodgment. The trusted data manager agrees upon details and establishes lodgment authority and validates security of electronic data with the trusted data provider, here by way of the line 46. And, the trusted data provider lodges data, also by way of the line 46. Upon subsequent service termination, the front-end user communicates such service termination with the trusted data provider through the trusted data manager by way of the lines 44 and 46.

FIG. 4 again illustrates elements of the arrangement 10 shown in FIG. 1. Again, an electronic security box 20, the trusted data manager and controller 28/24, the trusted data provider 30, and the front-end user 32 are again shown. Here, an electronic-security-box, secure access procedure is represented. Both the front-end user and the trusted data provider are provided with ESB (electronic security box) access tools approved by the trusted data manager and controller 28/24.

The front-end user and the trusted data manager agree, by way of the line 36/44, upon an access method and the tools required for secure electronic data access to the electronic security box. And, upon agreement, the trusted data manager provides, also by way of the line 36/44, the needed tool or tools to access the electronic security box. The trusted data manager and the trusted data provider agree, by way of the line 46, upon the access method and of the tool or tools needed for secure electronic data access to the electronic security box. And, the trusted data manager provides the needed tool or tools, by way of the line 46 to the trusted data provider.

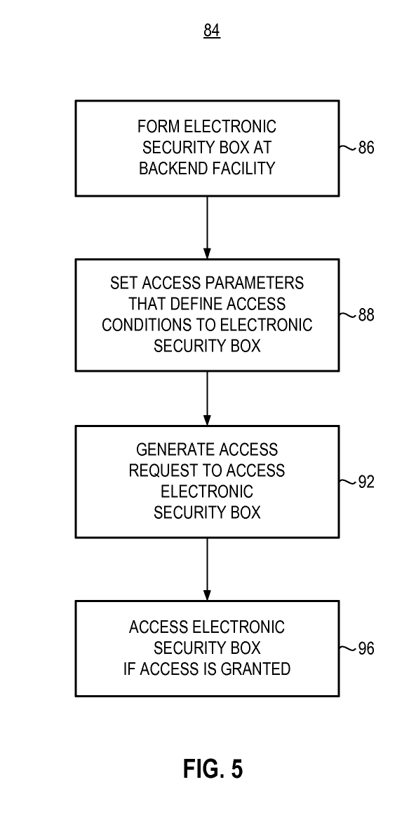

FIG. 5 illustrates a method flow diagram, shown generally at 84, representative of the method of operation of an embodiment of the present invention. The method archives front-end user data of a front-end user in electronic form at a back-end facility. The back-end facility is maintained by a facility operator.

First, and as indicated by the block 86, an electronic security box is formed at a storage device of the back-end facility. Then, and as indicated by the block 88, availability to the front-end user is provided, by a trusted data manager, to the electronic security box. And, as indicated by the block 92, access parameters that define access criteria needed to access the electronic security box are selected. And, as indicated by the block 96, access to the electronic security box is selectably granted to the front-end user.

Thereby, the front-end user is provided with an electronic security box at which the user is able to store, and access, the electronic data, once stored. Security is provided to ensure that only authorized entities are able to access the contents of the electronic security box.

The previous descriptions are of preferred examples for implementing the invention, and the scope of the invention should not necessarily be limited by this description. The scope of the present invention is defined by the following claims.

What is claimed is:

1. Apparatus for archiving front-end user data of a front-end user in electronic form at a back-end facility maintained by a facility operator, said apparatus comprising:
a storage device positioned at the back-end facility, said storage device configured selectably to store the front-end user data at an electronic security box formed selectably at said storage device and to permit access thereto;
a trusted data manager controller positionable in communication connectivity with the facility operator, said trusted data manager controller configured to cause creation of the electronic security box formed at said storage device and to cause selection of access parameters that define access criteria provided for access to the data stored thereat.

2. The apparatus of claim 1 wherein said storage device comprises a data server.

3. The apparatus of claim 1 wherein the back-end facility at which said storage device is positioned comprises a physically isolated facility, isolated physically from said trusted data manager controller.

4. The apparatus of claim 1 wherein the electronic security box formed at said storage device is of a first selected storage capacity.

5. The apparatus of claim 4 wherein said trusted data manager controller further controls selection of the first selected storage capacity of the electronic security box.

6. The apparatus of claim 1 wherein a trusted data manager operator operates said trusted data manager controller and wherein said trusted data manager controller is configured to be positioned remote from the trusted data manager operator.

7. The apparatus of claim 1 wherein said trusted data manager controller is further configured to be positionable in communication connectivity with the front-end user.

8. The apparatus of claim 1 wherein the access parameters caused to be selected by said trusted data manager controller are front end user related parameters.

9. The apparatus of claim 1 wherein the first end user is positionable in communication connectivity with said storage device and wherein the access parameters that define the access criteria are known to the front-end user.

10. The apparatus of claim 9 wherein the selectable access to the front-end user data stored at the electronic security box of said storage device is provided to the front-end user.

11. The apparatus of claim 10 further comprising a communication pathway formable between the front-end user and said storage device, the communication pathway configured to form a communication path for routing of a request made by the front-end user to access the front-end user data.

12. The apparatus of claim 11 wherein the trusted data manager controller is operated by a trusted data manager operator and wherein the communication path formed of said communication pathway provider for routing of the request free of routing by way of the trusted data manager operator.

13. The apparatus of claim 12 further comprising a request decider adapted to receive the request, the request decider configured to decide whether to grant the request communicated thereto by the front end user.

14. The apparatus of claim 13 wherein, upon grant by said request decider of the request, the front-end user data accessed by the front-end user is provided by way of the communication pathway.

15. A method for archiving front-end user data of a front-end user in electronic form at a back-end facility maintained by a facility operator, said method comprising the operations of:
forming an electronic security box at a storage device of the back-end facility;
providing, by a trusted data manager, availability to the front-end user the electronic security box;
selecting access parameters that define access criteria needed to access the electronic security box;
selectably granting access to the electronic security box to the front-end user.

16. The method of claim 15 wherein the facility operator and the trusted data manager comprise separate entities and wherein said method further comprises the operation of informing the trusted data manager of formation during said operation of forming of the electronic security box.

17. The method of claim 15 wherein said operation of selecting the access parameters is performed through interaction between the front-end user and the trusted data manager.

18. The method of claim 15 further comprising the operation of requesting, by the user, the access to the electronic security box, request made directly between the front-end user and the facility operator.

19. The method of claim 18 wherein the request includes the access parameter.

20. A system available to a bank that has a banking customer, said system comprising:
a third party storage device positioned remote from the bank, said third party storage device configured selectably to store banking customer data at an electronic security box formed at said third party storage device; and
a bank controller positionable in communication connectivity with the banking customer and with said third party storage device, said bank controller configured to cause selection of an access parameter that defines access criteria provided for access by the banking customer to the electronic security box.
